(19) United States
(12) Patent Application Publication
(10) Pub. No.: US 2008/0035819 A1
(43) Pub. Date: Feb. 14, 2008

(54) Beverage-container holder and blank therefor

(75) Inventors: Susan Wendy Garfin, Toronto (CA); Neal Warren Flewelling, Toronto (CA)

Correspondence Address: Susan Wendy Garfin, 45 Lower Village Gate, Toronto, ON, M5P 3L7, US

(73) Assignee: Susan Wendy Garfin, Toronto (CA)

(21) Appl. No.: 11/889,371

(22) Filed: Aug. 13, 2007

Related U.S. Application Data
(60) Provisional application No. 60/837,297, filed on Aug. 14, 2006.

(51) Int. Cl. B60N 3/10

(52) U.S. Cl. 248/311.2

(57) ABSTRACT

The invention disclosed herein is a beverage-container holder comprising suspension arm means with an upper end and a lower end arm suspension means with a container securement means for securely holding a beverage container attached to the suspension arm means at its lower end, and bar gripping means attached to the upper end of the suspension arm means for mounting the beverage-container holder to a horizontally extending bar to suspend the container securement means during use.

### BACKGROUND OF THE INVENTION

Drinking beverages in some common situations can be hazardous because the beverage container often has to be constantly held in the person's hand. When a person is mobile, there is no place to put the beverage. This can led to several unsafe situations, commonly attempted but which should not be attempted, such as walking a baby cart pushing the baby cart with one hand while holding the hot beverage cup with the other; pushing a shopping cart with one hand while holding a hot beverage with the other hand; or riding a bicycle one-handed with a hot beverage in the other hand. In these illustrative instances, the person even while not drinking the beverage no longer has both of their hands for controlling the buggy, cart or bicycle.

Other than carriages or shopping carts which are designed with pre-set holders for coffee cups, there has been no satisfactory solution to this problem. Most carriages, shopping carts, and practically, all bicycles, do not have cup holders for beverages. Also, it would be advantageous if the beverage-container holder could be easily removed and replaced as necessary—ie it would be advantageous if it was disposable.

It is an object of ht present invention to provide a beverage-container holder that can be easily mounted to and removed from mounting from a horizontal bar which would permit the person drinking from the beverage container to place the container down and intermittedly pick the container up to drink from it.

It is another object of the present invention to provide a beverage-container holder that can be mounted to hang from a horizontal bar and which will maintain the container placed thereon in a stable mounting while the horizontal bar is moved about, such was would be the situation with a shopping car, bicycle or baby carriage.

It is an object of the present invention to provide a beverage-container holder that is cheap and easy to manufacture.

It is an object of the present invention to provide a beverage-container holder that is easy to mount and dismount from a horizontal bar.

It is an object of the present invention to provide a beverage-container holder that can be made of disposable material.

It is an object of the present invention to provide a blank for making beverage-container holder that can be easily mounted to and removed from mounting from a horizontal bar which would permit the person drinking from the beverage container to place the container down and intermittedly pick up the container to drink from it.

Other objects will become apparent on reading the specification.

### SUMMARY OF THE INVENTION

According to an aspect of the present invention, there is provided a beverage-container holder comprising suspension arm means with an upper end and a lower end arm suspension means, there being a container securement means for securely holding a beverage container attached to the suspension arm means at its lower end, and bar gripping means attached to the upper end of the suspension arm means for mounting the beverage-container holder to a horizontally extending bar to suspend the container securement means during use.

According to another aspect of the present invention, there is provided a blank for making a beverage container holder, the blank comprising suspension arms with an upper end and a lower end, there being a container securement means for securely holding a beverage container attached to the suspension arm means at lower end of the suspension arm means, and bar gripping means attached to the upper end of the suspension arm means for mounting the beverage-container holder to a horizontally extending bar to suspend the container securement means during use.

### BRIEF DESCRIPTION OF THE DRAWINGS

The invention will more readily understood after reading the following description of the preferred embodiment and referring to the drawings in which:

FIG. 1 is an illustration of the preferred embodiment of the blank which can be used to make a beverage-container holder;

FIG. 2 is a perspective illustration of the preferred embodiment of the beverage container-holder made from the blank of FIG. 1 showing the embodiment suspended from a horizontal bar (drawn in ghost) and holding a beverage container (drawn in ghost);

FIG. 3 is an illustration of a second embodiment of a blank made in accordance with this invention which can be used to make a beverage-container holder having a bottom support wall;

FIG. 4 is a perspective illustration of the preferred embodiment of the beverage container-holder made from the blank of FIG. 3.

### DESCRIPTION OF THE PREFERRED EMBODIMENTS

In the drawings, similar parts of the embodiments are referred to by the same numbers.

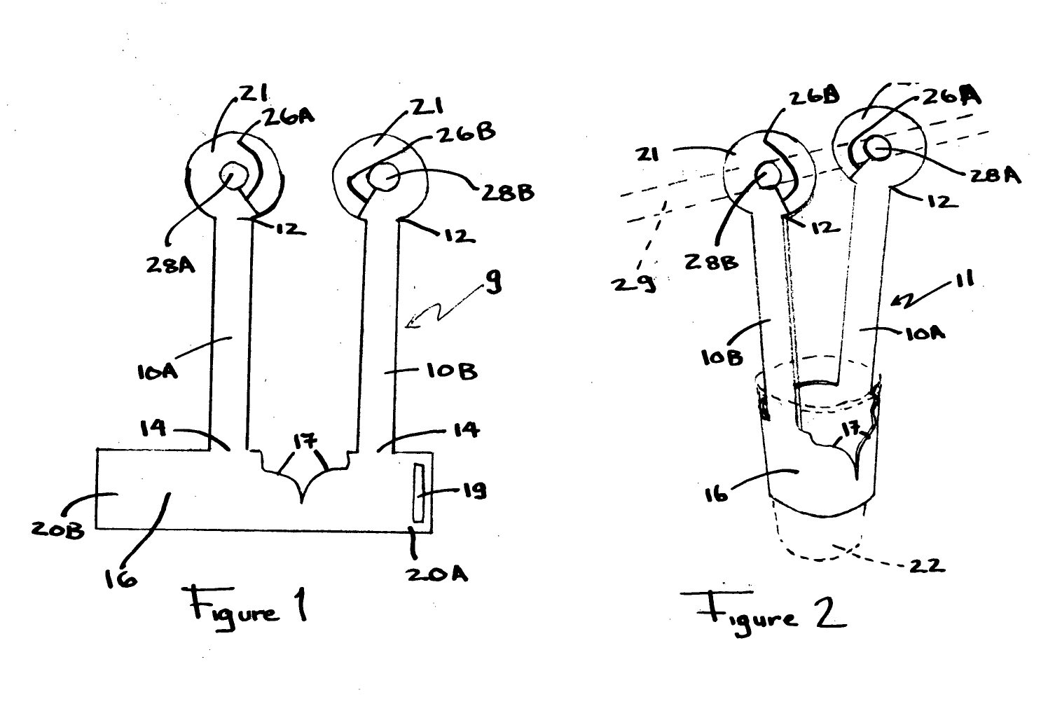

Referring to FIGS. 1 and 2, there is shown a blank, generally referred to by the numeral 9, comprising suspension arms 10A and 10B, each with an upper end 12 a lower end 14.

At the lower end 14, there is a side wall 16 which when assembled as in FIG. 2 will be circular in cross section. Formed on the upper edge of the side wall 16 are curved edges 17, which provide for easier access in and out of the beverage-container holder during use.

There is provided an application of adhesive 19 to the blank of FIG. 1 so that the blank can be easily assembled by a single connection by overlapping the portion 20A of the wall 16 having the adhesive with the opposite end portion 20B of the wall 16 to achieve the configuration as illustrated in FIG. 2.

When assembled, end portions 20A and 20B of wall 16 shall be attached together so that there shall be a support wall which will support a beverage container 22, shown in ghost, in FIG. 2.

At the upper ends 12 of the suspension arms 10A and 10B there are formed gripping hooks 21, formed with a mounting slits 26A and 26B and openings 28A, 28B. The slits permit mounting of each gripping arm onto a horizontal bar and the opening 28 of the gripping hooks are configured of a size and shape so that the beverage-container holder is frictionally secured to the horizontal bar with minimal sway and movement. A horizontal 29 bar is shown illustrated in ghost in FIG. 2 to indicate how the beverage container holder can be mounted.

The attaching of end portions 22A to 22B and end portions 24A and 24B can be attached together using glue or by interlocking slits or by any other manner chosen by the designer. Similarly, the arrangement of the slits 26A, 26B are also an issue of design as would be required to best fulfill the particular circumstances. In the embodiment shown, the slits configured to be so that the arms are mounted to the bar from opposite direction. This is a design feature to increase the security of the beverage container holder but it is not an essential feature. The manner of connection and the disposition of the slits can easily be chosen by a person or ordinary skill in the art to meet the required need.

As well, the disposition of the curved edges 17, which lower the level of the wall 16 at the front where the beverage container is placed in and out of the holder are optional, but they have been found to facilitate easier placement and removal, and an embodiment which provides a lower wall at the front for easier access is preferable.

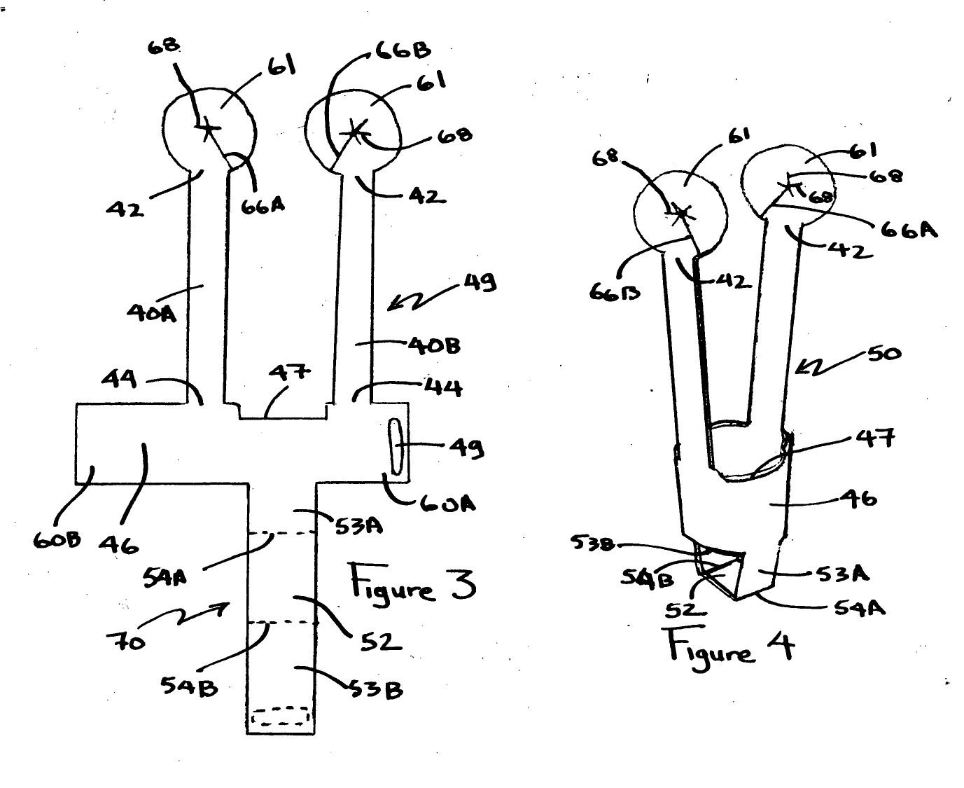

Referring to FIGS. 3 and 4, there is shown a blank and the beverage container holder, which has a support bottom wall.

In FIG. 3, there is shown a blank, generally referred to by the numeral 49, and in FIG. 4 there is shown the beverage container holder made from that blank, generally referred to by the numeral 50. As with the previous embodiment, they comprise suspension arms 40A and 40B, each with an upper end 42 a lower end 44.

At the lower end 44, there is a side wall 46 which when assembled as in FIG. 4 will be circular in cross section. Formed on the upper edge of the side wall 46 is a lowered upper front edge 47, which provides for easier access in and out of the beverage-container holder during use.

There is provided an application of adhesive 49 to the blank of FIG. 3 so that the blank can be easily assembled by a single connection by overlapping the portion 60A of the wall 46 having the adhesive with the opposite end portion 60B of the wall 46 to achieve the configuration as illustrated in FIG. 2.

When assembled, end portions 60A and 60B of wall 16 shall be attached together so that there shall be a support wall which will support a beverage container 22 at its side. However, where this embodiment differs from the previous embodiment, there is also provided a bottom support, generally referred to by the numeral 70, having a bottom portion 52, and side panel portions 53A, 53B separated from the bottom portion 52 by fold lines 54A and 54B. As shown in FIG. 3, there is provided on portion 53B, on the opposite side of the blank, an adhesive 56 for connecting the side panel portion 53B to the side wall 46 to achieve the embodiment as illustrated in FIG. 4.

At the upper ends 42 of the suspension arms 40A and 40B there are formed gripping hooks 61, formed with a mounting slits 66A and 66B and openings achievable through slits 68. The slits 68 permit the user to mount the beverage container holder to differently sized horizontal bars and achieve a frictional securement using the bent back triangular portions of the gripping hooks 61 which are defined by the arrangement of the slits 68. By radially extending the slits 68 from the center, triangular gripping teeth are defined which can be used to grip the horizontal bar. As with the previous embodiment, the gripping hooks are configured of a size and shape so that the beverage-container holder is frictionally secured to the horizontal bar with minimal sway and movement.

The manner of connection of the parts of the blank and the disposition of the slits can easily be chosen by a person or ordinary skill in the art to meet the required need.

As well, the disposition of the front access edge 47, which lowers the level of the wall 46 at the front where the beverage container is placed in and out of the holder is optional, but, as previously mentioned, having a lower edge at the front of the beverage-container holder has been found to facilitate easier placement and removal, and an embodiment which provides a lower wall at the front for easier access is preferable.

The blank can be made of cardboard, recycled paper or any material which would provide both the necessary structural strength for holding the cup, and then necessary frictional hold at the gripping portion to prevent undue sway or movement of the beverage container during use. The simple design lends itself to made either from recyclable material or recycled material and it can be preferably made from a unitary piece. As well, the material is preferably resilient to permit easy mounting of the gripping means during use.

By sloping the side wall, there is a further advantage of being able to nest the beverage-container holders after assembly.

Where only a side wall is required, the embodiment as shown in FIGS. 1 and 2, without a bottom wall, can be used effectively. However, if an embodiment is required to have a bottom wall, such as would be the case if the beverage was, for instance, a baby bottle, an embodiment such as that shown in FIGS. 3 and 4 could be used.

The actual shape, size and design will depend on the particular application and need of the user.

Many variations are possible.

By making the side arms of a material such as cardboard, the beverage-sup container is easily collapsible, removable, replaceable and reliable for this purpose. It is cheap and easy to manufacture.

Once mounted, the beverage-container holder provides a holder for the user to place their hot drink down between sips and to have the use of both hands while not drinking. This holder has advantages for bicycles, baby carriages and shopping cars and any other use, where there is provided a horizontal bar for suspension and a need to use both hands.

It is not intended that the specification be read in a limiting manner and that it is understood that the embodiment illustrated is the preferred embodiment. As will be apparent to those skilled in the art, other embodiments without deviating from the scope of the invention, are possible without deviated from the scope of the invention as defined in the appended claims attached hereto.

I claim:

1. A beverage-container holder comprising:
suspension arm means with an upper end and a lower end arm suspension means, there being a container securement means for securely holding a beverage container attached to the suspension arm means at its lower end, and bar gripping means attached to the upper end of the suspension arm means for mounting the beverage-container holder to a horizontally extending bar to suspend the container securement means during use.

2. A beverage-container holder as claimed in claim 1 wherein the beverage container holder is made from cardboard.

3. A beverage-container holder as claimed in claim 1 wherein the securement means comprises side-supporting wall

4. A beverage-container holder as claimed in claim 1 wherein the securement means comprises side-supporting wall and a supporting bottom wall.

5. A beverage-container holder as claimed in claim 1 wherein the bar-gripping means are formed with an opening to receive the horizontal bar during use and a slit to permit mounting of the beverage-container for use.

6. A beverage container holder as claimed in claim 1 wherein the beverage container holder is made from a resilient material.

7. A beverage-container holder as claimed in claim 1 wherein the bar gripping means is formed by radially extending slits to define triangular teeth to grip the handle bar when mounted.

8. A beverage-container holder as claimed in claim 1 wherein the container is made from a unitary piece of cardboard.

9. A blank for making a beverage container holder, the blank comprising suspension arms with an upper end and lower end, there being a container securement means for securely holding a beverage container attached to the suspension arm means at the lower end of the suspension arm means an bar gripping means attached to the upper end of the suspension arms means for mounting the beverage-container holder to a horizontally extending bar to suspend the container securement means during use.

10. A blank for making a beverage-container holder as claimed in claim 9 wherein the blank is made from cardboard.

11. A blank for making a beverage-container holder as claimed in claim 9 wherein the securement means comprises a side-supporting wall.

12. A blank for making a beverage-container holder as claimed in claim 9 wherein the securement means comprises a side-supporting wall and a supporting base.

13. A blank for making a beverage-container holder as claimed in claim 9 wherein the bar-gripping means are formed with an opening to receive the horizontal bar during use and a slit to permit mounting of the beverage-container made from the blank.

14. A blank for making a beverage container holder as claimed in claim 9 wherein the blank is made from a resilient material.

15. A blank for making a beverage-container holder beverage-container holder as claimed in claim 9 wherein the bar gripping means is formed by radially extending slits to define bar-gripping teeth.
